(19) United States
(12) Patent Application Publication
(10) Pub. No.: US 2004/0195798 A1
(43) Pub. Date: Oct. 7, 2004

(54) Reclining chair with caster system

(76) Inventors: Donald Newfer, Auburn, IN (US); Joel Alberda, Leo, IN (US)

Correspondence Address: BAKER & DANIELS, 111 E. WAYNE STREET, SUITE 800, FORT WAYNE, IN, 46802

(21) Appl. No.: 10/145,644

(22) Filed: May 15, 2002

(51) Int. Cl. B62M 1/14; B62B 1/00; B62B 5/00

(52) U.S. Cl. 280/250.1; 280/79.11

(57) ABSTRACT

A caster system and a brake system for a reclining chair. The caster system includes two non-swiveling, load bearing casters and four swivel casters mounted to the base of the chair. The swivel casters are mounted near the comers of the base with one load bearing caster located between each pair of front and back swivel casters. The swivel casters allow for rotation of the chair in any direction while the load bearing casters maintain a linear path in the direction of movement of the chair. The caster system provides a zero-turning radius and user control over the movement of the chair. The brake system is associated with the load bearing casters to stop rotation thereof by means of a single actuating lever. Recesses are formed in the chair sides in which the reclining and brake levers are received such that the levers do not extend beyond the width of the chair.

### BACKGROUND OF THE INVENTION

The present invention relates to a reclining chair, and more particularly to a caster system for the reclining chair.

Conventionally, reclining chairs which are used in environments such as residential homes, convalescent homes, nursing homes, hospitals, or the like, may be provided with a caster system. Caster systems, including four casters, for reclining chairs are generally secured to the chair base with one caster located near each corner thereof. The casters may be e.g., fixed or swivel casters.

When the caster system of the reclining chair is provided with four swivel casters, the reclining chair has a very small turning radius. The chair can rotate while staying in substantially one place. Thus, rotation of the chair takes up no more space than that required by the size of the chair. A problem with having only swivel casters mounted to the reclining chair base is that, in straight travel, the direction of movement of the chair is difficult to control. None of the casters have a predetermined path so that they have a tendency to turn and cause the chair to rotate even when the chair is pushed in a particular direction. This tendency of the chair to rotate makes moving the chair along a linear path difficult. In order to keep the chair traveling in a straight line, the direction in which the chair is pushed must be constantly adjusted. The tendency of the chair to rotate creates further difficulties when the user of the chair wants or needs to have control over the movement of the chair. It is difficult for the user of the chair to remain seated and move the chair using his feet, for example. The person using the chair is then dependent upon someone else to steer the chair. This situation is aggravated by the fact that users of such chairs tend to be disabled or elderly.

Alternatively, one of the front or rear pair of casters may be fixed casters and the other pair of casters may be swivel casters. The fixed casters maintain a predetermined, linear path as the chair is moved while the swivel casters allow for rotation of the chair. A problem with having a pair of fixed and a pair of swivel casters is that the turning radius of the chair is increased. The chair rotates about one of the fixed casters, thus making the turning radius equivalent to the width of the chair, and therefore requiring additional space to maneuver the chair. Further, user control over the movement of the chair may still be difficult, particularly when navigating the chair around corners or other obstacles. Additionally, the fixed or swivel casters of conventional caster systems for reclining chairs are usually large and unattractive, taking away from the aesthetically pleasing appearance of an upholstered chair.

Once the chair is in a desired location, at least two of the four casters should be locked to prevent movement of the chair. A locking mechanism is conventionally provided on each caster which when actuated maintains the position of the chair. A problem with this conventional type of locking system is that each caster must be individually locked. The user of the chair would have to get out of the chair to lock the casters. This may be difficult for the person in the chair if the person is e.g., injured or recovering from surgery. The person using the chair is then dependent upon someone else to lock and unlock the casters.

A reclining lever is generally located on one side of the chair within arm's reach of the person using the chair. The lever is used to recline the footrest and back of the chair. Conventionally, reclining levers extend outward beyond the width of the chair. When maneuvering the chair, the levers may bump into doorjambs, get caught in bed linens, or the like. People may also inadvertently walk into the reclining levers.

It is desired to provide a reclining chair with a caster system which is user controllable and has a very small turning radius, a brake system which locks the position of the chair with actuation of a single recessed lever, and an aesthetically pleasing appearance.

### SUMMARY OF THE INVENTION

The present invention relates to a caster system including a brake system for a reclining chair. The caster system includes six casters, two of which are larger, non-swivelable load-bearing casters. The remaining four casters are swivel casters mounted near the corners of the chair base. A decorative leg is mounted to the base in a position to substantially hide the swivel casters from view. Each load-bearing caster is positioned along one side of the chair, intermediate the front and back swivel casters. A brake system enables locking of the two load-bearing casters by actuating a single lever. Defined in the sides of the chair are recesses or cavities in which the reclining and brake levers are located. Further, located between the arm caps and the chair sides are gaps through which restraints may be placed if a person must be held in the chair.

One advantage of the present invention is that the large stationary, load-bearing casters provide for a zero-turning radius, while also serving to maintain the direction in which the chair is being moved, thereby permitting easy movement of the chair.

An additional advantage of the present invention is that the caster system provides good user control over the movement of the chair in that the person sitting in the chair is able to move the chair without being dependent upon someone else.

A further advantage of the present invention is that cavities are provided in the sides of the chair to recess and thus protect the recliner and brake levers.

Still another advantage of the present invention is that the chair is aesthetically pleasing with the swivel casters being substantially hidden by decorative legs.

A still further advantage of the present invention is that the reclining chair, equipped with footrests, can be used to transport people who are not very mobile without having to transfer them to a wheelchair.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of a reclining chair in accordance with the present invention;

FIG. 2 is a bottom plan view of the reclining chair of FIG. 1;

FIG. 3 is a perspective view of the base of the reclining chair of FIG. 1;

FIG. 4 is a sectional view of the brake system taken along line 4-4 of Figure 3, showing the brake system disengaged;

FIG. 5 is a side elevational view of the brake system of FIG. 4, showing the brake system engaged; and

FIG. 6 is a side elevational view of the reclining chair of FIG. 1 showing the footrest in a reclined position.

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE INVENTION

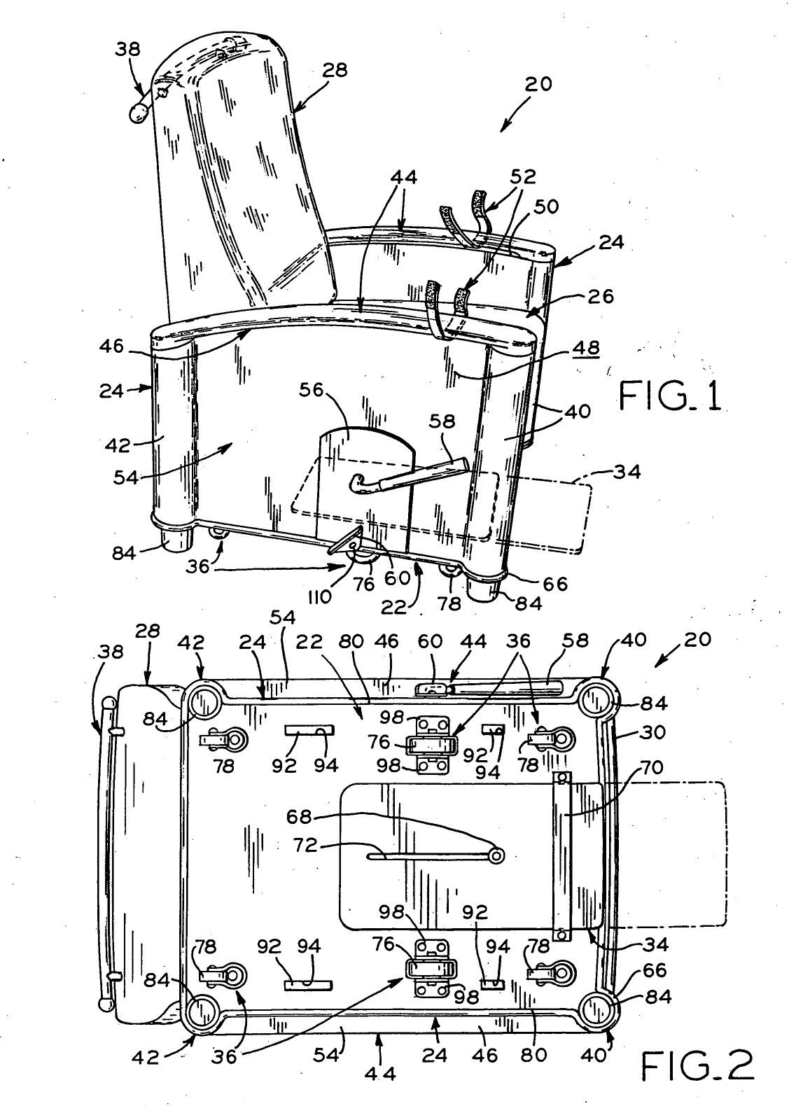

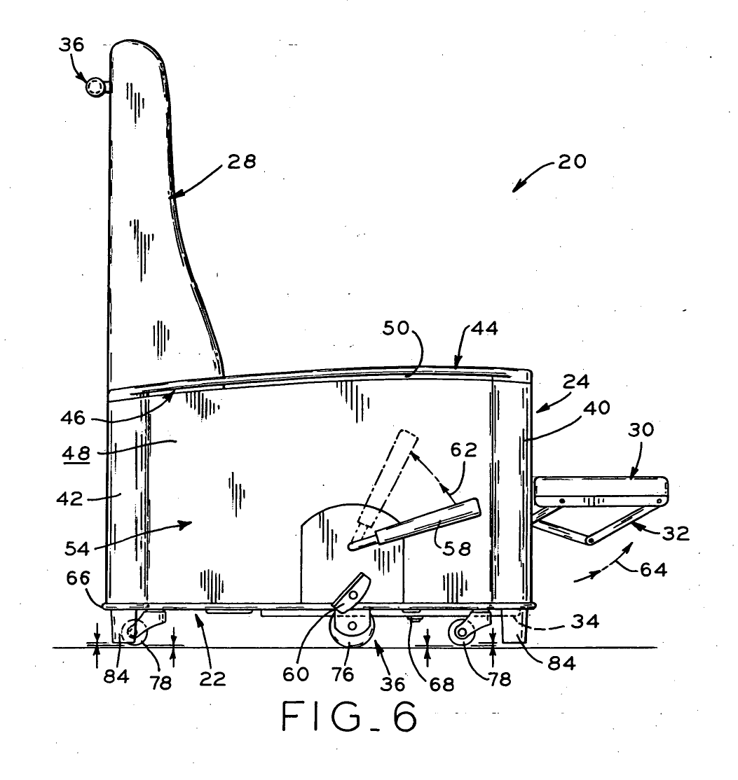

Referring to FIGS. 1 and 2, reclining chair 20 generally includes base 22 supporting sides 24, which stand substantially perpendicular from base 22. Chair seat 26 and chair back 28 are attached to reclining mechanism mounting brackets 88 and 90, with chair back 28 extending substantially perpendicularly from the rear of seat 26. Chair back 28 and reclining footrest 30 (FIGS. 2 and 6) are mounted, using any suitable conventional method, to reclining mechanism 32 for pivotal movement into and out of a reclined position as illustrated in FIG. 6. Secured to the back of chair back 28 is push bar 38 which is constructed from any suitable, decorative material including plastic, wood, or the like. Mounted to the lower surface of base 22 is a secondary, sitting or transporting footrest 34 which may be manually pulled out from underneath chair 20. Also mounted to base 22 is caster system 36 which will be discussed further hereinbelow.

As illustrated in FIGS. 1 and 2, sides 24 of chair 20 are provided with rounded portions located substantially perpendicularly to base 22 along the front and back edges of sides 24. The rounded portions form the cavity into which recliner lever 58 and brake lever 60 are recessed. Mounted to the upper surface of sides 24 are arm caps 44 each of which has a portion 46 which overhangs a surface 48 of a side 24. Overhanging portion 46 of arm caps 44 forms a grip or handle that a person sitting in chair 20 may use to pull against when getting up out of the chair. Arm caps 44 may also be designed to provide a gap or slot 50 (FIGS. 1 and 6) between the lower surface of arm cap 44 and the upper surface of side 24. Restraints 52 may be passed through slots 50 and used to restrain a person in chair 20 (FIG. 1).

Referring to FIGS. 1 and 2, front column 40, back column 42, and overhanging portion 46 together define cavities or recesses 54 in sides 24. Mounted in a recess 54 of one side 24 is plate 56 supporting reclining lever 58 and brake lever 60. Levers 58 and 60 extend from surface 48 of side 24. However, recess 54 is sized such that levers 58 and 60 do not extend beyond front and back columns 40 and 42, thus protecting the levers from contacting doorjambs or walls, getting caught in bed linens, or the like. Further, people cannot inadvertently walk into levers 58 and 60 when they are recessed behind columns 40 and 42. As shown in FIG. 6, when reclining lever 58 is actuated in the direction of arrow 62, reclining footrest 30 extends outwardly in the direction of arrow 64 as is conventional. Further actuation of lever 58 reclines chair back 28.

As shown in FIG. 2, sitting and transporting footrest 34 is also secured to base 22 by guide pin 68 and bracket 70. Bracket 70 is secured to base 22 using any suitable fastener near the front edge of chair 20 to support footrest 34. Guide pin 68 is received in slot 72 formed in footrest 38. As footrest 38 is pulled from or repositioned underneath chair 20, footrest 34 travels along guide pin 68 a distance equal to the length of slot 72. Referring to FIGS. 1, 2, and 3, edge bumper 66 is formed about the outer periphery of base 22 to protect chair 20, particularly chair arms 44, from coming into contact with a wall or doorjamb, for example. Base 22 and footrest 34 are covered with a protective material such as urethane to provide a hard, durable, protective finish.

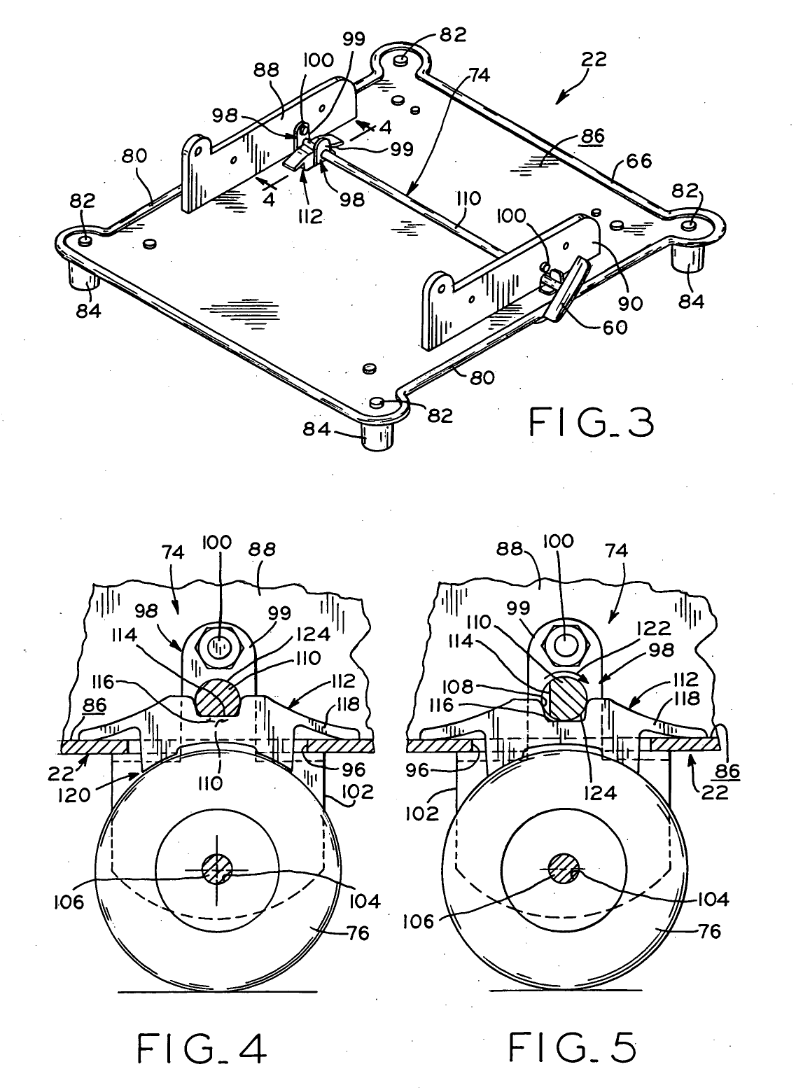

Referring to FIGS. 2 and 3, also mounted to base 22 is caster system 36 including brake system 74. Caster system 36 includes six casters, two load bearing casters 76 and four swivel casters 78. Brake system 74 is associated with load bearing casters 76 to lock the position of chair 20. Swivel casters 78 are located near the corners of base 22. Load bearing casters 76 are each positioned between two swivel casters 78 along sides 80 of base 22. Apertures 96 (FIGS. 4 and 5) are provided in base 22 at the position of load bearing casters 76 to receive a portion thereof which will be contacted by brake system 74 as will be discussed hereinbelow. Decorative chair legs 84 are mounted to base 22 using fasteners 82 and are positioned adjacent to each caster 78 to substantially hide casters 78 from view. Load bearing casters 76 are larger and more substantial than swivel casters 78, and are able to withstand the loads created during use of chair 20. Further, the size of load bearing casters 76 may make maneuvering chair 20 easier, e.g., maneuvering over thresholds.

Load bearing casters 76 are in contact with the ground at all times. Swivel casters 78 are located a distance above the ground when chair 20 is balanced upon load bearing casters 76 as shown in FIG. 6. In one embodiment, swivel casters 78 are at a distance of approximately 1/16 of an inch above the ground. Along with load-bearing casters 76, only the front or rear pair of swivel casters 78 is generally in contact with the ground, depending on the weight distribution of chair 20. For example, with a person sitting against back 28 of chair 20, the rear swivel casters 78 will be in contact with the ground, and the front swivel casters 78 will be out of contact with the ground. Alternatively, when the person is getting out of chair 20, chair 20 pivots about load bearing casters 76 until the front pair of swivel casters 78 are in contact with the ground, and the rear casters 78 are out of contact with the ground.

The combination of load bearing casters 76 and swivel casters 78 provides chair 20 with a zero-turning radius, permitting the chair to be easily oriented. Load bearing casters 76 maintain a linear path in the direction in which chair 20 is being moved. Swivel casters 78 allow for the chair to remain stable when moved or at rest. Casters 76 and 78 further provide user control over the movement of the chair so that the person sitting in chair 20 can move chair 20 with his feet, for example. This is beneficial in that the person using chair 20 is not dependent upon additional help to move the chair. Further, for persons recovering from an injury or surgery, independently moving chair 20 may provide a form of physical therapy. The larger size of casters 76 also helps in making the chair easier to move.

Referring to FIGS. 3-5, brake system 74 of caster system 36 is mounted to upper surface 86 of base 22 and is associated with load bearing casters 76. As shown in FIG. 3, support members 88 and 90 are secured to base 22. Support members 88 and 90 are positioned substantially parallel to sides 80 and substantially perpendicular to base 22. Referring to FIG. 2, support members 88 and 90 are provided with tabs 92 received in slots 94 located within base 22 to secure members 88 and 90 to base 22.

As shown in FIG. 2, a pair of support brackets 98 are mounted to base 22. Upper portion 99 of one support bracket 98 extends upwardly through apertures 96 and is affixed to support members 88 and 90 using fastener 100 (FIGS. 3-5). As illustrated in FIGS. 4 and 5, lower portion 102 of supporting brackets 98 have apertures 104 located therein for rotatably receiving the ends of axle 106 extending through load bearing caster 76. Upper portion 99 has apertures 108 therein in which brake rod 110 is rotatably supported. Brake pedal 60 is secured to an end of brake rod 110 which extends through support member 90 and one side 24.

Located between the pair of support brackets 98 is brake pad 112. Brake pad 112 is secured to brake rod 110 such that flat portion 114 of brake rod 110 (FIGS. 4 and 5) aligns with flat portion 116 of brake pad 112. Brake pad 112 may be affixed to rod 110 by any suitable means including fasteners or interference fit. One flat portion 114 is located near each end of brake rod 110 such that one brake pad 112 will be positioned above each load bearing caster 76. Brake pads 112 are constructed from any suitable material having flexibility and durability to withstand forces created when the brake is applied. Brake pad 112 includes flanged portion 118 which engages upper surface 86 of base 22. Flanged portion 118 flexes as brake system 74 is engaged and acts to help return brake pads 112 to a disengaged position when brake pedal 60 is returned to its initial position.

As shown in FIG. 4, when flat portions 114 and 116 are engaged with one another, brake pad 112 is not engaged. Gap 120 exists between brake pad 112 and caster 76. As brake pedal 60 is rotated in the direction of arrow 122 (FIG. 5), flat portion 114 of brake rod 110 rotates out of engagement with flat portion 116 of brake pad 112. Rounded portion 124 of rod 110 comes into contact with flat portion 116, forcing brake pad 112 downwardly against load bearing casters 76 to arrest rotation of load bearing casters 76 and to prevent movement of chair 20.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A caster system for an article of furniture, said system comprising:
a base;
a plurality of swivel casters secured to said base for swiveling cooperation with a supporting ground surface; and
at least one non-swiveling caster secured to said base, said non-swiveling caster always in contact with said supporting ground surface.

2. The caster system of claim 1 wherein said plurality of swiveling casters comprises four swiveling casters.

3. The caster system according to claim 1 including two non-swiveling casters.

4. The caster system according to claim 1 including four swiveling casters and two non-swiveling casters.

5. The caster system according to claim 1 wherein said non-swiveling caster is larger than said swiveling casters.

6. The caster system of claim 1 wherein not all said swiveling casters are simultaneously in contact with said supporting surface.

7. A wheeled chair comprising:
a base;
four swivel casters secured to said base for swiveling cooperation with a supporting ground surface; and
two non-swiveling casters secured to said base, said non-swiveling casters always in contact with said supporting surface.

8. The caster system according to claim 7 wherein said non-swiveling casters are larger than said swiveling casters.

9. The chair according to claim 7 wherein not all said swiveling casters are simultaneously in contact with said supporting ground surface.

10. The chair according to claim 7 further comprising a reclining surface;
a cavity in an outside surface of said chair;
an actuating lever disposed in said cavity, said lever operatively connected to said reclining surface for movement of said surface between an upright position and a reclining position.

11. The chair according to claim 10 further comprising a moveable footrest, said footrest operatively connected to said actuating lever for movement of said footrest between two positions.
